(19) United States
(12) Patent Application Publication
(10) Pub. No.: US 2009/0049755 A1
(43) Pub. Date: Feb. 26, 2009

(54) STEPPED FRAMES FOR STEEL CLOSURES

(76) Inventors: James Arthur Rohrer, SR., Mesa, AZ (US); Sandra Lee Rohrer, Mesa, AZ (US); James Arthur Rohrer, JR., Mesa, AZ (US)

Correspondence Address: KEITH L. JENKINS, 2222 NORTH MCQUEEN ROAD #2069, CHANDLER, AZ, 85225, US

(21) Appl. No.: 11/842,942

(22) Filed: Aug. 21, 2007

(51) Int. Cl. E06B 1/04

(52) U.S. Cl. 49/504

(57) ABSTRACT

A structural steel stepped closure frame is disclosed having a closure stop that is spaced apart from the closure jamb and discontinuously joined thereto, forming gaps between the closure jamb and the closure stop. The gaps and joinery are obscured from frontal view by a stop face positioned forward of the closure stop, creating a partially hidden closure stop. The partially hidden closure stop may extend entirely around the closure for windows or lids, or less than entirely for doors or gates. The gaps receive legs of a weather stripping that has a flange extending over the closure stop. The partially hidden closure stop, along with the jamb, extensions, and facings, are sized, shaped, and arranged to create a stepped appearance.

### FIELD OF THE INVENTION

The present invention relates to closure frames made of steel. More particularly, the present invention relates to a steel closure frame having a partially hidden closure stop.

### BACKGROUND OF THE INVENTION

Steel closure frames include, without limitation, steel doorframes, steel window frames, steel transom frames, steel gate frames, and steel fence gate frames. There are two general classes of metal closure frames. First, there are lightweight frames made from thin metal sheets folded into desirable frame shapes, as is known in the art of making mobile homes. Such lightweight closure frames are not of interest here. Second, and of primary interest here, are heavy steel closure frames, such as are used to support massive decorative ironwork doors. Such steel doorframes may be custom built for the entryways of high-end customers. The following disclosure will describe the invention primarily in terms of such a doorframe, with further description regarding other closures where minor variations are needed.

Problems have arisen in producing heavy steel doorframes related to speed of installation and overall appearance. Conventional steel doorframes meet the finished walls into which they are installed with at least part of the outermost perimeter of the doorframe inside the wall. This necessitates, during installation, coordinating with workmen from other trades to perform such tasks as drywall hanging, stucco application, painting, etc., in order to create an acceptable appearance. The coordination and the work cost extra time and money. In retrofit steel doorframes, it is often difficult to find a tradesman who will do the job because it is not enough work to justify the travel time to the job. Frequently, the results do not age well. The wall materials and the steel are subject to different rates of thermal expansion and contraction on hot and cold days, respectively, resulting in separation at the boundary of the steel doorframe and the wall material. Fractures of the wall materials are common near the boundary, producing a highly undesirable appearance.

Another issue that arises with steel entryway doors is the weather stripping. Weather stripping that is adhesively bonded to the steel tends to peel off with age, leaving a lack of weather stripping and an unsightly appearance.

Another problem with the appearance of conventional steel doorframes is their tendency to look industrial. Steel doorframes are used in industrial applications, both for external service doors and interior fire doors. Decoration may be applied to the metal surface of the doorframe, but that alone creates an unsatisfying appearance and adds a large cost.

The inventors have recognized a need for improvements to steel doorframes to produce an easily-installed attractive steel closure. The inventors have also recognized a need for a steel entryway doors with improved weather stripping. The inventors have also recognized a need for steel window frames, particularly in decorative ironwork doors and in steel doorframes for such doors, which have an improved appearance and improved weather stripping. In order to meet those needs, and to solve related problems, the inventors have developed the novel steel closure frame of the present invention.

### OBJECTS AND FEATURES OF THE INVENTION

A primary object and feature of the present invention is to provide an improved steel closure frame that is easily installed. It is a further object and feature of the present invention to provide such an improved steel closure frame with improved appearance. It is a further object of the invention to provide an improved steel closure frame with improved weather stripping. It is yet another object of this invention to provide an improved steel closure frame with stepped appearance. It is yet another object and feature of the present invention to provide such an improved steel closure frame with at least a 5-stepped appearance. It is still yet another object and feature of the present invention to provide such an improved steel closure frame with a partially hidden closure stop. A further object of this invention is provide an improved steel closure frame that is serviceable for doors, windows, transoms, gates, sidelights, and lids. A further primary object and feature of the present invention is to provide such a closure that is attractive, durable, and serviceable. Other objects and features of this invention will become apparent with reference to the following descriptions.

### SUMMARY OF THE INVENTION

In accordance with a preferred embodiment hereof, this invention provides a tubular steel closure jamb having a closure jamb header connecting two closure jamb side members defining an inner perimeter, each said closure jamb side member having a bottom end. It further provides a partially hidden closure stop, comprising a closure stop spaced apart from the inner perimeter of the steel closure jamb by a first distance and discontinuously joined to at least a portion of the steel closure jamb by joinery spanning the first distance, thereby forming a plurality of gaps between the closure stop and the steel closure jamb. The closure stop face is coupled to the steel closure jamb wherein the closure stop face is sized, shaped, and arranged to at least partially obscure the plurality of gaps from view.

Moreover, it provides that the closure stop and the closure stop face may be joined. Moreover, it provides an intermediate stop member that may be disposed between and coupled to the closure stop face or the closure stop, the intermediate stop member spaced apart from the steel closure jamb by a second distance. Further, it provides a resilient weather strip, the weather strip comprising a resilient flange sized, shaped, and arranged to extend over the rear surface of the closure stop and at least two resilient legs extending from the resilient flange, wherein each resilient leg of the at least two resilient legs is sized, shaped, and arranged to securely fit into one gap of the plurality of gaps.

The preferred embodiment also provides a front extension having a front extension member fixed to the steel closure jamb and having a front extension front surface alignable parallel to such front panel surface and a front facing, fixed to less than all of the front extension front surface and extending outwardly proximate to such front panel surface. The preferred embodiment also provides a rear extension having a rear extension member having a rear extension rear surface alignable parallel to such rear panel surface and a rear facing, fixed to less than all of the rear extension rear surface and extendable outwardly adjacent to such rear panel surface, wherein said at least one rear extension is operable to be fixed in abutment to the steel closure jamb. Moreover, it provides a footer connecting the bottom ends and has a top surface with a step fixed to the top surface and further fixed to the tubular steel closure jamb proximate the bottom ends.

In the preferred embodiment, the closure frame may be a doorframe, a window frame, a window frame in a doorframe, or a window frame in a door. In a variation for a window frame, the tubular steel closure jamb may have a tubular steel closure jamb footer connecting the closure jamb members distal the closure jamb header and a closure stop spaced apart from and discontinuously joined to the tubular steel closure jamb footer by a first distance. Moreover, the preferred embodiment has a portion of a hinge coupled to the tubular steel closure jamb.

In accordance with another preferred embodiment hereof, this invention provides.

### BRIEF DESCRIPTION OF THE DRAWINGS

The above and other objects and advantages of the present invention will become more apparent from the following description taken in conjunction with the following drawings in which:

FIG. 1A shows a rear elevation view illustrating a first exemplary embodiment of a steel closure frame, according to a preferred embodiment of the present invention;

FIG. 1B shows a front elevation view illustrating the steel closure frame of FIG. 1, according to a preferred embodiment of the present invention;

FIG. 2 shows a horizontal sectional view illustrating the steel closure frame of FIG. 1, according to a preferred embodiment of the present invention;

FIG. 3 shows a top plan view illustrating the steel closure frame of FIG. 1, according to a preferred embodiment of the present invention;

FIG. 4 shows a horizontal sectional view illustrating the welding points on the steel closure frame of FIG. 1, according to a preferred embodiment of the present invention;

FIG. 5 shows a front elevation view illustrating a second exemplary embodiment of a steel closure frame having additional steel closure frames therein, according to a preferred embodiment of the present invention;

FIG. 6 shows a front elevation view illustrating a third exemplary embodiment of a steel doorframe having and arched head jamb, according to a preferred embodiment of the present invention;

FIG. 7 shows a horizontal sectional view illustrating an exemplary two-part steel closure frame similar to FIG. 1, according to a preferred embodiment of the present invention;

FIG. 8 shows an exploded horizontal sectional view illustrating an exemplary two-part steel closure frame similar to FIG. 1, according to a preferred embodiment of the present invention;

FIG. 9 shows a rear elevation view illustrating some details of the exemplary embodiment of FIG. 1, and defining section A-A and B-B, according to a preferred embodiment of the present invention;

FIG. 9A shows cross-sectional view A-A, defined in FIG. 9, illustrating a detail of the exemplary embodiment of FIG. 1, according to a preferred embodiment of the present invention;

FIG. 9B shows cross-sectional view B-B, defined in FIG. 9, illustrating another detail of the exemplary embodiment of FIG. 1, according to a preferred embodiment of the present invention;

FIG. 10 shows a cross-sectional view similar to section B-B, defined in FIG. 9, illustrating another exemplary embodiment of a steel closure frame with weather stripping, according to a preferred embodiment of the present invention;

FIG. 11 shows the cross-sectional view through section B-B, defined in FIG. 9, illustrating the exemplary embodiment of FIG. 1 with weather stripping, according to a preferred embodiment of the present invention;

FIG. 12 shows a front elevation view of an exemplary embodiment of weather stripping for the exemplary embodiment of a steel closure frame of FIG. 11, according to a preferred embodiment of the present invention;

FIG. 13 shows a cross-sectional view similar to section B-B, defined in FIG. 9, illustrating yet another exemplary embodiment of a steel closure frame with weather stripping, according to a preferred embodiment of the present invention;

FIG. 14 shows a transverse cross-sectional view of another exemplary embodiment of a steel closure frame, according to a preferred embodiment of the present invention;

FIG. 15 shows a top plan view illustrating the exemplary embodiment of FIG. 14, according to a preferred embodiment of the present invention;

FIG. 16 shows a front elevation view illustrating an exemplary embodiment of a steel window closure frame in a door in an exemplary embodiment of a steel closure frame of FIG. 1, according to a preferred embodiment of the present invention;

FIG. 17 shows a rear elevation view illustrating an exemplary embodiment of a steel window frame in a door supported in an exemplary embodiment of a steel closure frame of FIG. 16, according to a preferred embodiment of the present invention; and

FIG. 18 is a transverse cross-sectional view illustrating the exemplary embodiment of FIG. 16, according to a preferred embodiment of the present invention.

### DETAILED DESCRIPTION OF THE BEST MODES AND PREFERRED EMBODIMENTS OF THE INVENTION

The terms “inner” and “outer” as used herein refer to radial relationships relative to the center of an opening, such as a doorway, for which a closure, such as a door, is provided. The terms “front” and “rear” as used herein are only relative to two sides of an opening, such as a doorway, and a closure, such as a door, or a closure frame, such as a doorframe, is provided. The terms “front” and “rear” have no absolute direction. Thus, the portion designated as “rear” might be employed facing outward on the front of a house, if desired.

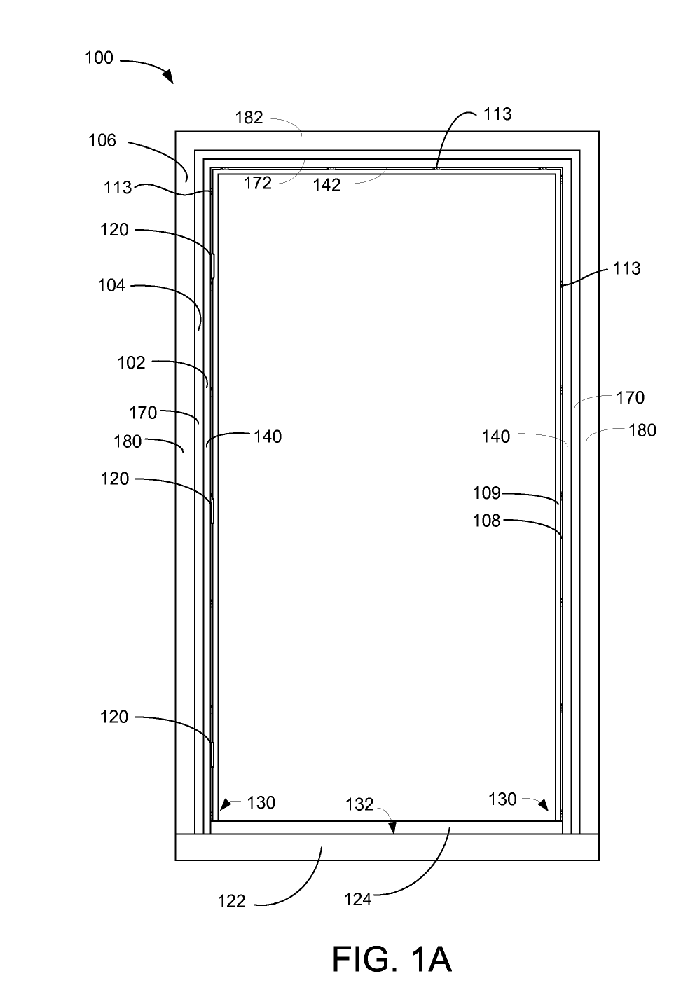

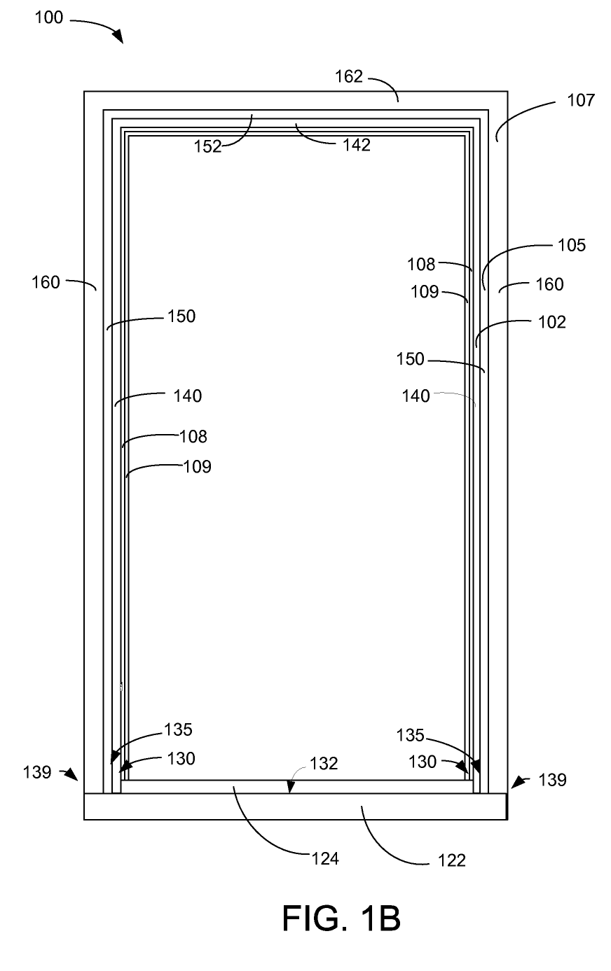

FIG. 1A shows a rear elevation view illustrating a first exemplary embodiment of a steel closure frame 100, according to a preferred embodiment of the present invention. Steel closure frame 100 includes steel closure jamb 102, rear extension 104, rear facing 106, closure stop 109, and stop face 108. Preferably, steel closure jamb 102, rear extension 104, rear facing 106, closure stop 109, and stop face 108 are made of structural steel tubing 0.125 inches thick and having rectangular transverse cross-sections with rounded edges. At least a portion of one or more flexible couplings 120 are fixed to steel closure jamb 102. Flexible couplings 120 are preferably hinges and are most preferably pin-barrel hinges. The steel closure jamb 102, rear extension 104, rear facing 106, closure stop 109, and stop face 108, when assembled, create a stepped appearance, with the surfaces facing the observer receding into the distance inwardly, except for stop face 108, which is behind (in FIG. 1A) closure stop 109.

Steel closure jamb 102 includes closure jamb side members 140 spaced apart and connected by a closure jamb header 142. The inner surfaces of closure jamb side members 140 and closure jamb header 142 define an inner perimeter of the steel closure frame 100. In a preferred embodiment, closure jamb side members 140 are parallel and of substantially equal length, while closure jamb header 142 is straight and perpendicular to both closure jamb side members 140. Closure jamb side members 140 each have a bottom end 130 distal closure jamb header 142. Steel closure jamb 102 is preferably joined to closure jamb side members 140 by welding a forty-five degree miter joint between the steel tubing of the closure jamb header 142 and the steel tubing of the jamb side members 140. In some alternate embodiments, such as those with an arched closure jamb header 142, a different angle for the joint may be appropriate. While the illustrated preferred embodiment is for a rectangular closure frame, the invention is not so limited. Closures of various shapes, including shapes having one or more curves, are within the scope of the invention.

Rear extension 104 includes rear extension side members 170 spaced apart and connected by at least one rear extension header 172. In a preferred embodiment, rear extension side members 170 are parallel and of substantially equal length, while rear extension jamb header 172 is straight and perpendicular to both closure jamb side members 170. Rear extension jamb 104 is preferably joined to rear extension side members 170 by welding a forty-five degree miter joint between the steel tubing of the rear extension jamb header 172 and the steel tubing of the rear extension side members 170. In some alternate embodiments, such as those with an arched rear extension jamb header 172, a different angle for the joint may be appropriate.

Rear facing 106 includes rear facing side members 180 spaced apart and connected by at least one rear facing header 182. In a preferred embodiment, rear facing side members 180 are parallel and of substantially equal length, while rear facing header 182 is straight and perpendicular to both rear facing side members 180. Rear facing 106 is preferably joined to rear facing side members 180 by welding a forty-five degree miter joint between the steel tubing of the rear facing header 182 and the steel tubing of the rear facing side members 180. In some alternate embodiments, such as those with an arched rear facing header 182, a different angle for the joint may be appropriate.

Closure stop 109 is spaced apart from steel closure jamb 102 and is discontinuously joined to the steel closure jamb 102 by joinery 113. Joinery 113 spans the space between closure stop 109 and steel closure jamb 102. Preferably, joinery 113 includes welding. In alternate embodiments, other types of joinery 113 may be used. For example, in a particular alternate embodiment, bolts with washers or nuts for spacers may be used. The spacing between steel closure jamb 102 and closure stop 109 is preferably more than 0.0625 inches and less than 0.375 inches, and is most preferably 0.125 inches. In an alternate embodiment, smaller or larger spacing may be used. In the embodiment shown, closure stop 109 is discontinuously joined to the entire steel closure jamb 102. In various alternate embodiments, the closure stop 109 may be extend along less than the entire inner perimeter of steel closure jamb 102. For example, in a particular embodiment, the closure stop 109 may be provided in sections with small gaps between them. In various other alternate embodiments, such as for window closures, the closure stop 109 may extend along the entire rectangular inner perimeter of a steel closure jamb 102, including along the bottom.

Footer 122 spaces apart and connects bottom ends 130 and may support or connect to the rear extension 104 and rear facing 106, as shown. In an alternate embodiment, footer 122 may support or connect to closure stop 109 and stop face 108. Footer 122 has a top surface 132 that supports step 124. Opposing ends of step 124 may abut or be joined to steel closure jamb 102. Step 124 may support or connect to closure stop 109 and stop face 108.

FIG. 1B shows a front elevation view illustrating the steel closure frame 100 of FIG. 1, according to a preferred embodiment of the present invention. Steel closure frame 100 includes steel closure jamb 102, rear extension 104, rear facing 106, closure stop 109, and stop face 108. Preferably, steel closure jamb 102, front extension 105, front facing 107, closure stop 109, and stop face 108 are made of structural steel tubing 0.125 inches thick and having rectangular transverse cross-sections with rounded corners. Steel closure jamb 102, front extension 105, front facing 107, closure stop 109, and stop face 108 are joined together to create a stepped appearance of five steps. The comparative widths to the steps, as shown in FIG. 1B, is not a limitation of the invention: the widths in a particular closure may be different to create a different desired visual effect. For example, the front facing 107 may be wider and the front extension 105 narrower.

Front extension 105 includes front extension side members 150 spaced apart and connected by at least one front extension header 152. In a preferred embodiment, front extension side members 150 are parallel and of substantially equal length, while front extension header 152 is straight and perpendicular to both front extension side members 150. Front extension header 152 is preferably joined to front extension side members 150 by welding forty-five degree miter joints between the steel tubing of the front extension header 152 and the steel tubing of the front extension side members 150. In some alternate embodiments, such as those with an arched front extension header 152, a different angle for the joint may be appropriate. Front extension side members 150 have bottom ends 135 supported by and, optionally, connected to, footer 122.

Front facing 107 includes front facing side members 160 spaced apart and connected by at least one front facing header 162. In a preferred embodiment, front facing side members 160 are parallel and of substantially equal length, while front facing header 162 is straight and perpendicular to both front facing side members 160. Front facing 107 is preferably joined to front facing side members 160 by welding forty-five degree miter joints between the steel tubing of the front facing header 162 and the steel tubing of the front facing side members 160. In some alternate embodiments, such as those with an arched front facing header 162, a different angle for the joint may be appropriate. Front facing side members 160 have bottom ends 139 supported by and, optionally, connected to, footer 122. Those of skill in the art, enlightened by this disclosure, will appreciate the various forms that the front facing 107 may take. For example, the front facing may include a decorated surface or an outer perimeter of a decorative shape.

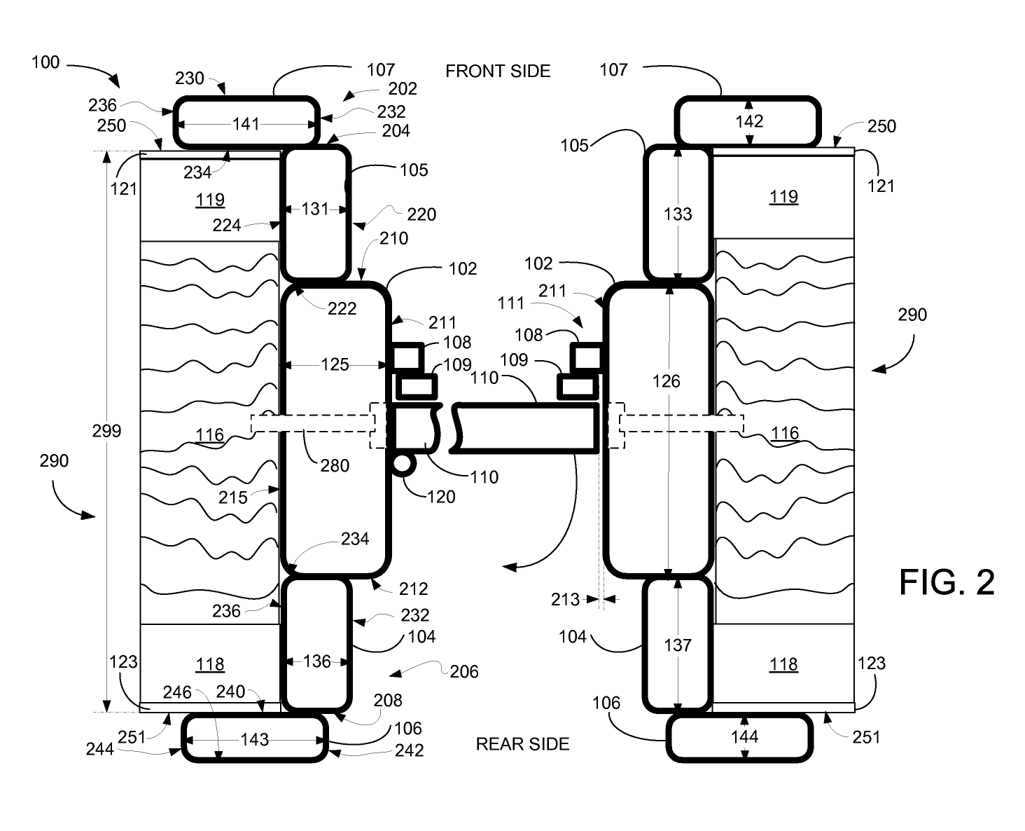

FIG. 2 shows a horizontal transverse sectional view illustrating the steel closure frame 100 of FIG. 1, according to a preferred embodiment of the present invention. Steel closure frame 100 is preferably installed in and engages a panel, such as wall 290, which comprises framing stud 116, front wall material 119, front finish 121 having front surface 250, rear wall material 118, and rear finish 123 having rear surface 251, the sum of materials creating a wall thickness 299. The wall illustrated in FIG. 2 is exemplary and not limiting. Panels of various sorts may provide opportunities for installation of steel closure frame 100. For example, a garden wall or an iron fence may serve the function of wall 290. Steel closure jamb 102 is preferably a “2×4” of structural steel tubing of one-eighth-inch tube-wall thickness and having a rectangular cross-section. Steel closure jamb 102 has a width 125, a depth 126, a front surface 210, a rear surface 212, and inner (relative to the doorway) surface 211, and an outer (relative to the doorway) surface 213. The outer surface 215 of steel closure jamb 102 preferably abuts wall stud 116 and is fastened thereto with fastener 280. Fastener 280 is preferably a bolt with a head recessed into steel closure jamb 102 at a location that is concealed when the door 110 is closed. At least a portion of a flexible coupling 120 is fixed to the inner surface 211 of steel closure jamb 102. Flexible coupling 120 is preferably a hinge and more preferably a pin barrel hinge. Flexible coupling 120 flexibly couples door 110 to steel closure jamb 102.

Closure stop 109 is spaced apart from the inner surface 211 of steel closure jamb 102, by spacing 213, as shown. Closure stop 109 is joined to steel closure jamb 102 by discontinuous joinery that is not shown in FIG. 2, but which will be discussed and illustrated below. Closure stop face 108 is preferably joined to surface 211 of steel closure jamb 102 in a position that blocks human observation of space 213 from the front. In an alternate embodiment, closure stop face 108 may be joined to surface 210 and extend inwardly to block observation of space 213 from the front. Preferably, closure stop face 108 is also joined to closure stop 109, but the invention is not so limited, as will be discussed in greater detail below. Closure stop 109 and closure stop face 108, when arranged to block observation of spacing 213, together form partially hidden closure stop 111.

Front extension 105 is made of structural steel tubing of rectangular cross-sectional shape, preferably having a tube-wall thickness of at least one-eighth inch. Front extension 105 has a front extension width 131, which is preferably less than the width 125 of steel closure jamb 102. Front extension 105 has a front surface 204, rear surface 222, inner (relative to the closure opening) surface 220 and an outer (relative to the closure opening) surface 224. Preferably, the rear surface 222 of front extension 105 is joined to less than all of the front surface 210 of steel closure jamb 102, thereby creating a stepped appearance. Front extension 105 has a depth 133 that is selected to align the front surface 204 of front extension 105 to front surface 250 of front finish 121. For walls having a standard thickness 299, standard depths for front extension 105 may be used. For walls having a custom wall thickness 299, front extension 105 may be custom made. In a preferred embodiment, the outer surface 215 of steel closure jamb 102 is aligned with outer surface 224 of front extension 105.

Front facing 107 is made of structural steel tubing of rectangular cross-sectional shape, preferably having a tube-wall thickness of at least one-eighth inch. Front facing 107 has a width 141, a depth 142, a front surface 230, rear surface 234, inner (relative to the closure opening) surface 232, and outer (relative to the closure opening) surface 236. Less than all of rear surface 234 of front facing 107 is joined to less than all of front surface 204 of front extension 105, creating a stepped appearance. At least a portion of rear surface 234 of front extension 107 is proximate front surface 250 of front finish 121. In a preferred embodiment, rear surface 234 of front facing 107 abuts a flat front surface 250 of front finish 121. In an alternative embodiment, rear surface 234 may be slightly spaced apart from front surface 250. For example, if front finish 121 is stucco on a foam-panel-and-wire front wall material 119, rear surface 234 and front surface 250 may be slightly spaced apart to allow for the rough texture of the stucco and to accommodate a bead of silicone caulking material (not shown) there between. The choice of position of rear surface 234 relative to front surface 250 is made to avoid requiring finish work to front finish 121 or to the surface 250 thereof.

Rear extension 104 is made of structural steel tubing of rectangular cross-sectional shape, preferably having a tube-wall thickness of at least one-eighth inch. Rear extension 104 has a width 136 that is preferably less than width 125 of the steel closure jamb 102. Rear extension 104 has a depth 137 selected to align rear surface 208 of rear extension 104 to rear surface 251 of rear finish 123. Rear extension 104 has front surface 234 that, in an installed closure, abuts less than all of rear surface 212 of steel closure jamb 102, thereby creating a stepped appearance. Preferably, the outer (relative to the doorway) surface 236 of rear extension is aligned with rear surface 213 of steel closure jamb 102 when the steel closure frame 100 is installed. Rear extension 104 has inner (relative to the doorway) surface 232.

Rear facing 106 is made of structural steel tubing of rectangular cross-sectional shape, preferably having a tube-wall thickness of at least one-eighth inch. Rear facing 106 has a width 143, a depth 144, a rear surface 246, a front surface 240, an inner (relative to the closure opening) surface 242, and an outer (relative to the closure opening) surface 244. Less than all of front surface 240 of rear facing 106 is joined to less than all of the rear surface 208 of the rear extension 104, producing a stepped appearance. The position of rear surface 240 relative to front surface 251 of rear finish 123 is determined in a manner similar to that for the front facing 107.

All of the visible surfaces 236, 230, 232, 204, 220, 210, 211, 212, 232, 208, 232, 246, and 244 may, in particular embodiments, be decorated by any known means including, without limitation, shaping, embossing, molding, and engraving. While the preferred embodiment is made of rectangular structural steel tubes, structural steel tubes of other cross-sectional shapes may be used in various alternate embodiments. For example, in a particular alternate embodiment, tubes having an irregular trapezoidal cross-sectional shape may be used. Preferably, the manufactured steel closure frame 100 is powder coated to provide a uniform color and texture.

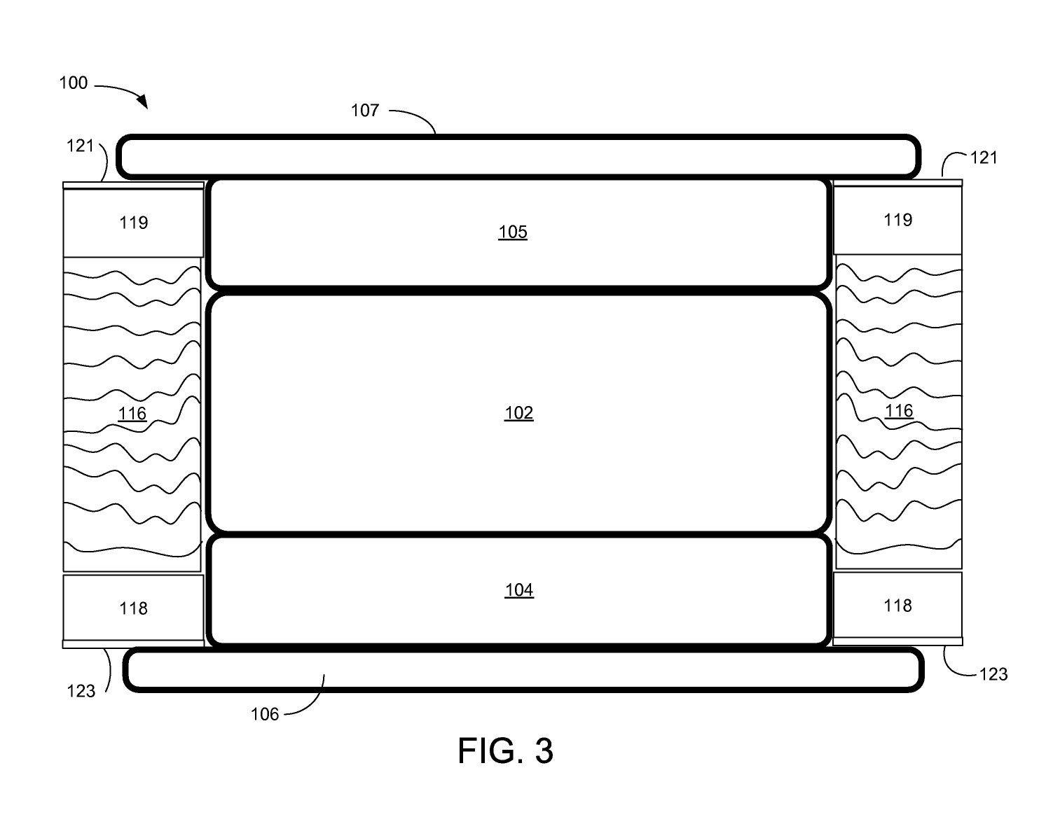

FIG. 3 shows a top plan view illustrating the steel closure frame of FIG. 1, according to a preferred embodiment of the present invention. Front facing 107 extends over front finish 121 and is joined to front extension 105. The outer edges of front extension 105 abut the wall and are joined to steel closure jamb 102. The outer edges of steel closure jamb 102 abut the wall and abut the rear extension 104. Rear facing 106 extends over rear finish 123 and is joined to rear extension 104.

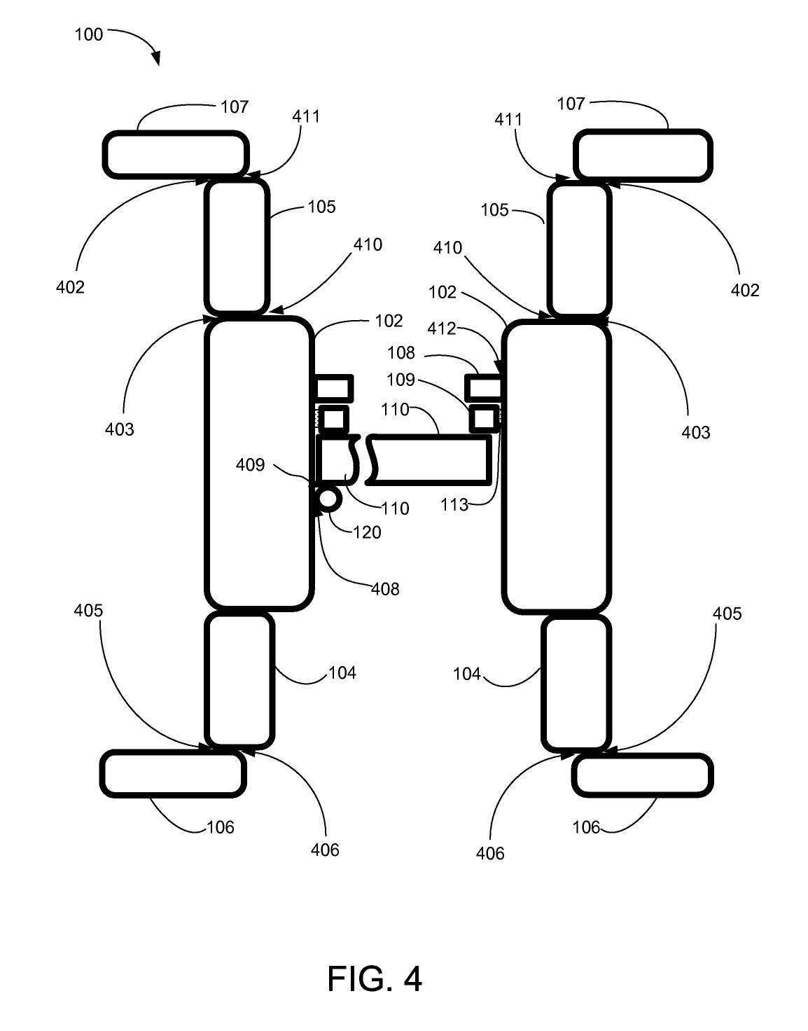

FIG. 4 shows a horizontal sectional view illustrating exemplary welding points on the steel closure frame of FIG. 1, according to a preferred embodiment of the present invention. Preferably, front facing 107 is welded to front extension at joints 402 and 411. The welds are preferably one to two inches long and spaced apart by two to three feet. The longer welds and the shorter spacings are preferred for more massive steel closure frames 100. Preferably, front extension 105 is joined to steel closure jamb 102 at joints 403 and 410. Preferably, pin barrel hinge 120 is welded to steel closure jamb 102 at joint 408 and to door 110 at joint 409. Preferably, stop face 108 is welded to steel closure jamb 102 at joint 412 and closure stop 109 is welded to steel closure jamb 102 using a bridge weld 113 to bridge spacing 213. Preferably, rear extension 104 is welded to rear facing 106 at joints 405 and 406. In the preferred embodiment, rear extension 104 is not joined to steel closure jamb 102 by joinery, but is abutted against steel closure jamb 102 during installation. Welds are finished, as by grinding, to avoid unsightly aberrations inn the stepped appearance of the steel closure frame 100. While welding has been disclosed in the preferred embodiment, other metal joining techniques, such as bolting, may suffice in particular alternate embodiments.

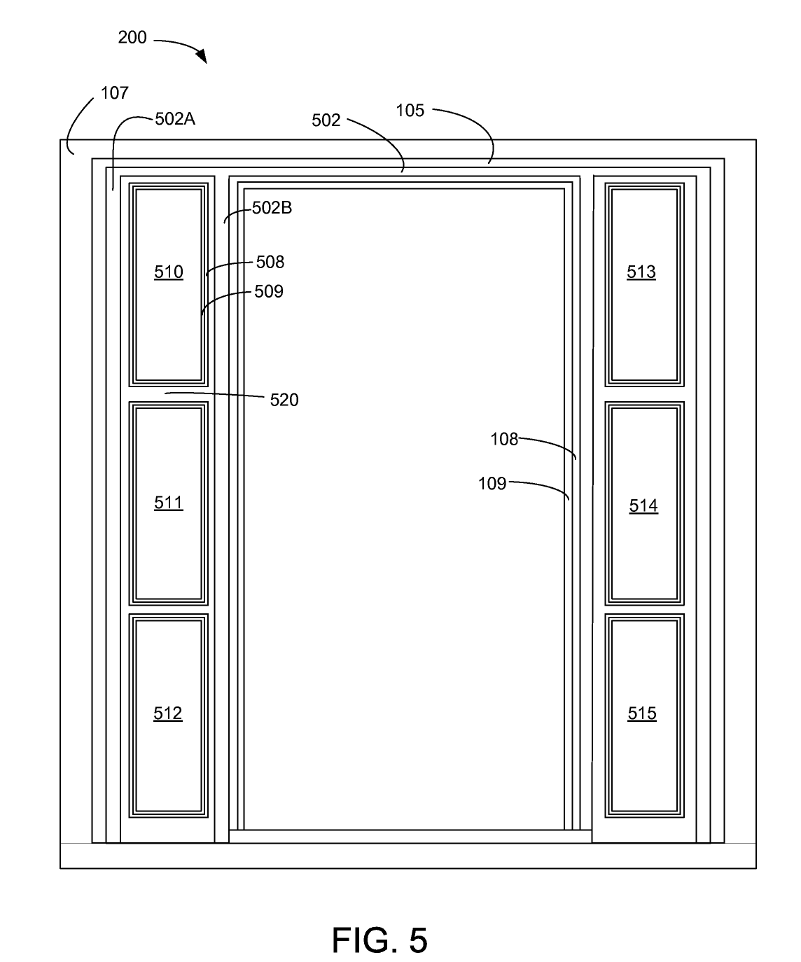

FIG. 5 shows a front elevation view illustrating a second exemplary embodiment of a steel closure frame 200 having steel closure frames 510-515 therein, according to a preferred embodiment of the present invention. Front facing 107 and front extension 105 differ only in dimensions from the embodiment FIG. 1. Steel closure jamb 502 has dual side jamb members 502A and 502B which frame steel closure frames, or window frames, 510-515. Side jamb members 502A and 502B may be attached to sidelight frame 520, which forms window frames 510-515. Each window frame 510-515 may have a stop face 508 and a closure stop 509 attached in a similar manner to the attachment of stop face 108 and closure stop 109 to steel closure jamb 102. Within window frames 510-515, the stop face 508 and closure stop 509 are attached around the entire internal perimeter of each window frame 510-515. In a preferred embodiment, the windows in frames 510-515 are flexibly coupled and are flush-mounted into the window frames 510-515 as viewed from the rear.

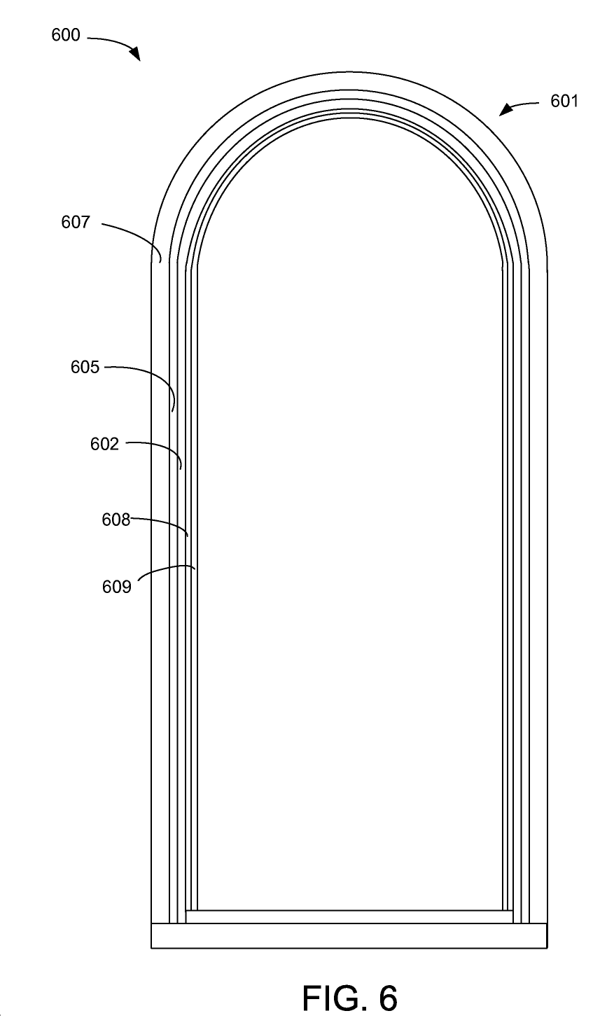

FIG. 6 shows a front elevation view illustrating a third exemplary embodiment of a steel closure frame 600 having and arched steel head jamb 602, according to a preferred embodiment of the present invention. Arched head jamb 602 is joined to arched front extension 605 that is attached to front facing 607. A radial cross section through the arch 601 would be similar to FIG. 2 without the door 110 and flexible couplings 120. Closure stop 609 and closure face 608 are similar to closure stop 109 and closure face 109, except that closure stop 609 and closure face 608 each have an arched portion.

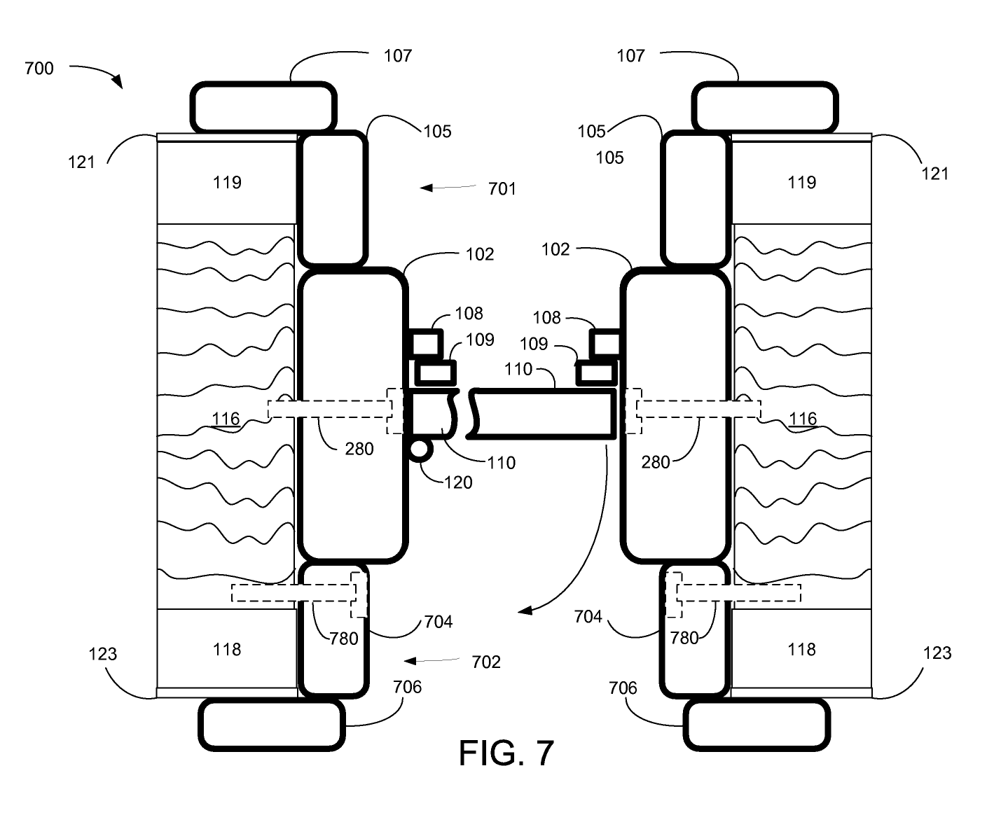

FIG. 7 shows a horizontal sectional view illustrating an exemplary two-part steel closure frame of FIG. 1, with an additional fastener 780 according to a preferred embodiment of the present invention. The first part 701 of the steel closure frame 700 includes the steel closure jamb 102, rear extension 105, front facing 107, stop face 108, and closure stop 109. Second part 702 of steel closure jamb 700 includes rear extension 704 and rear facing 706. Fasteners 780 are used to secure rear extension 704 to framing stud 116. In various alternate embodiments, part 701 and part 702 may be fastened together, either additionally or alternatively.

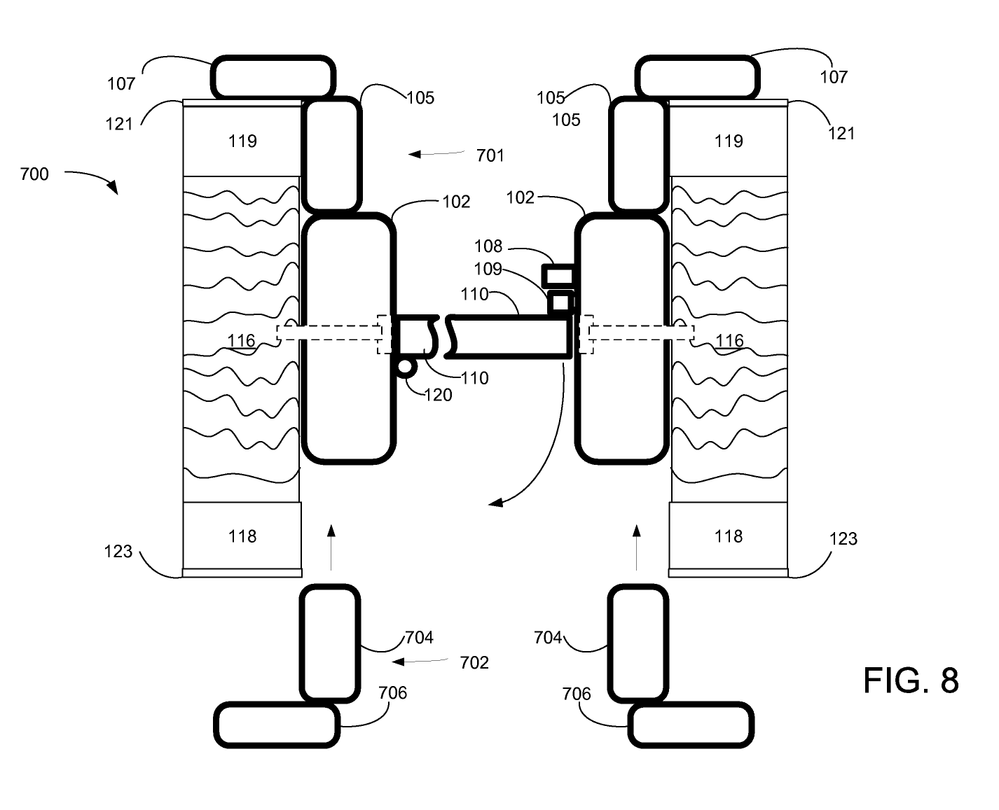

FIG. 8 shows an exploded horizontal sectional view illustrating an exemplary two-part steel closure frame 700 of FIG. 7, according to a preferred embodiment of the present invention. Part 701 is shown installed in the wall and part 702 is positioned to be installed. After moving forward (as indicated by the arrows), part 702 will abut part 701 and will be fastened to the wall, as shown in FIG. 7. In a particular alternate embodiment, parts 701 and 702 may be joined before installation and the wall then built around the free-standing steel closure 100, 200, or 600.

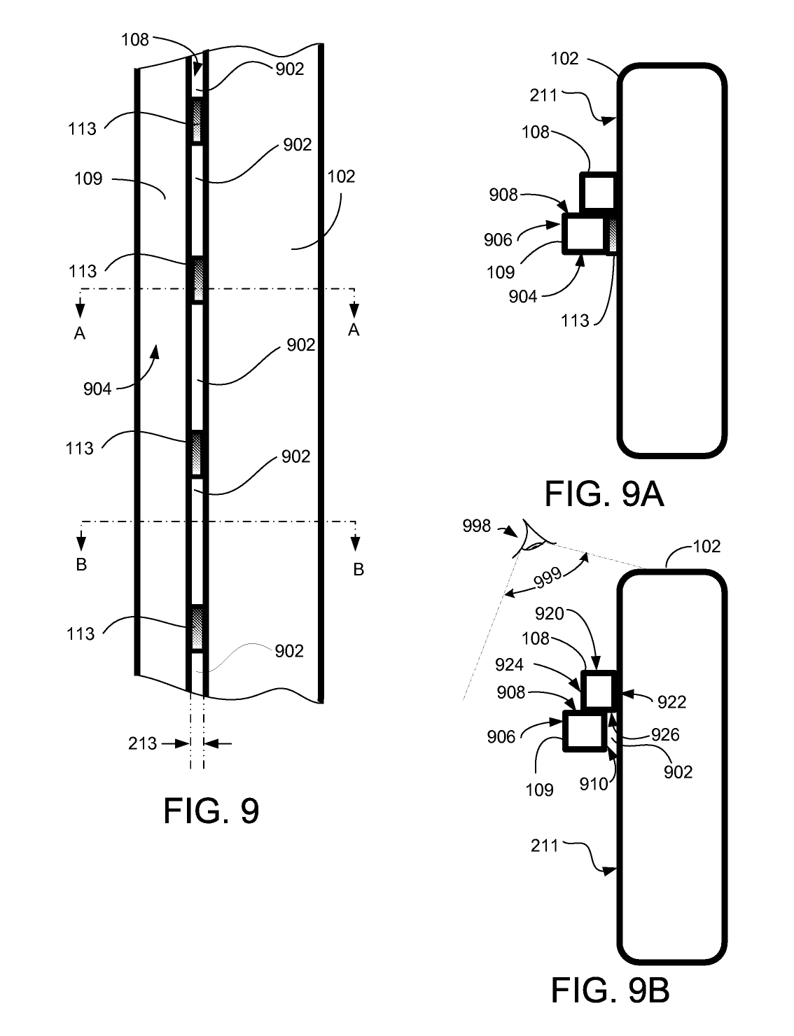

FIG. 9 shows a rear elevation view illustrating some details of the exemplary embodiment of FIG. 1, and defining section A-A and B-B, according to a preferred embodiment of the present invention. Closure stop 109 is shown spaced apart from steel closure jamb 102 by space 213. The rear surface 904 of closure stop 109 faces rearward. Joinery 113, which is discontinuous along the space 213 between closure stop 109 and steel closure jamb 102, joins closure stop 109 to steel closure jamb 102. Joinery 113 is preferably welding. Joinery 113 creates a plurality of gaps 902. Gaps 902 between joinery 113 may extend completely between closure stop 109 and steel closure jamb 102. Stop face 108 may be seen through the gaps 902. Section A-A is through a joinery 113. Section B-B is through a gap 902.

FIG. 9A shows cross-sectional view A-A, defined in FIG. 9, illustrating a detail of the exemplary embodiment of FIG. 1, according to a preferred embodiment of the present invention. In the embodiment illustrated in FIG. 9A, stop face 108 is joined to surface 211 of steel closure jamb 102 and to front surface 908 of closure stop 109. Closure stop 109 is further joined to surface 211 of steel closure jamb 102 by joinery 113, which is preferably a weld. Steel closure jamb 102, stop face 108, and closure stop 109 create a stepped appearance when observed from the front (top of the page, in this view).

FIG. 9B shows cross-sectional view B-B, defined in FIG. 9, illustrating another detail of the exemplary embodiment of FIG. 1, according to a preferred embodiment of the present invention. Outer (relative to the doorway) surface 910 of closure stop 109 is spaced apart from surface 211 of steel closure jamb 102 by gap 902. Rear surface 926 of stop face 108 is exposed in the gap 902. Outer (relative to the doorway) surface 922 of stop face 108 is at least partially joined to surface 211 of steel closure jamb 102. From a forward point of view 996 with a viewing angle 999, surfaces 211, 920, 924, 908, and 906 are visible, creating the desired stepped appearance.

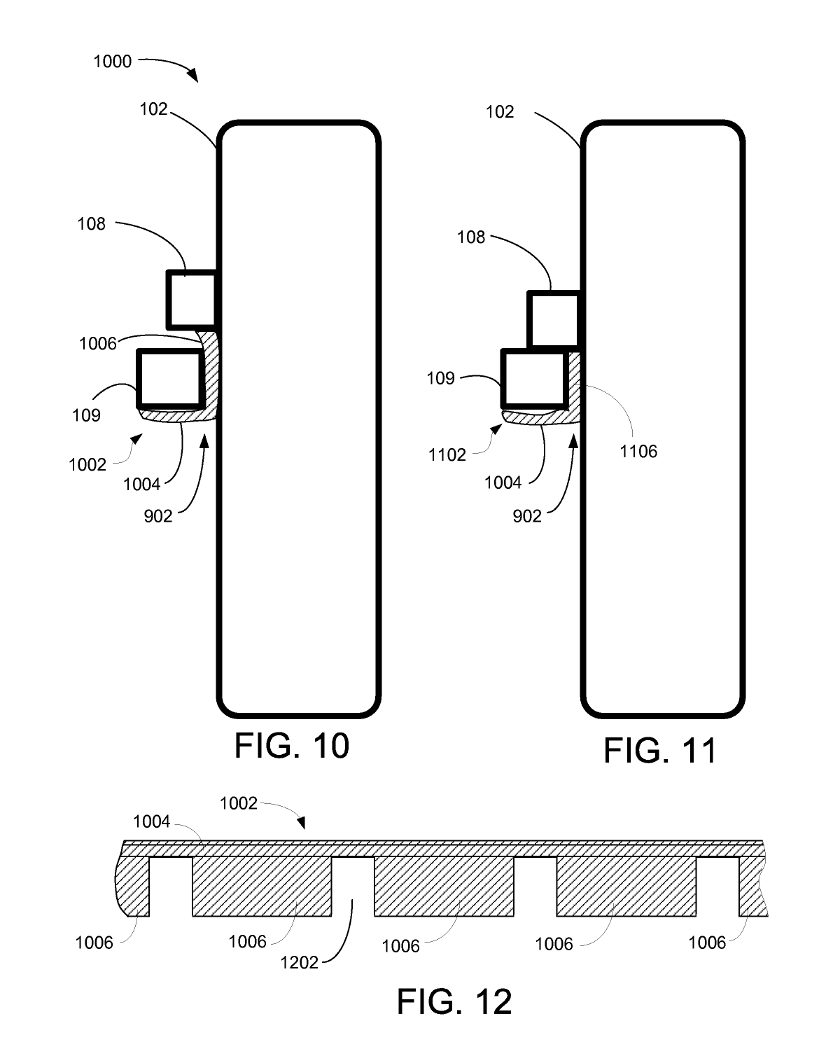

FIG. 10 shows a cross-sectional view similar to section B-B, defined in FIG. 9, illustrating another exemplary embodiment of a steel closure frame 1000 with weather stripping 1004, according to a preferred embodiment of the present invention. Closure stop 109 is discontinuously joined to steel closure jamb 102, and the view of FIG. 10 is a section through a gap 902. Stop face 108 is spaced apart from closure stop 109 but still serves the purpose of concealing gap 902 (and joinery 113) from frontal view. Weather stripping 1002 has a leg 1006 which fits snuggly into gap 902 and extends to stop face 108. Weather stripping 1002 also has a resilient flange 1004 which extends at least partially over rear surface 904 (see FIG. 9A) of closure stop 109. Flange 1004 is shown as having a generally arcuate cross-sectional shape, but other shapes may be used. Flange 1004 is intended to deform when compressed by the closure of a door 110 or the like.

FIG. 11 shows the cross-sectional view through section B-B, defined in FIG. 9, illustrating the exemplary embodiment of FIG. 1 with weather stripping 1102, according to a preferred embodiment of the present invention. Closure stop 109 is discontinuously joined to steel closure jamb 102, and the view of FIG. 11 is a section through a gap 902. Stop face 108 is at least abutting and may be joined to closure stop 109 and serves the purpose of concealing gap 902 (and joinery 113) from frontal view. Weather stripping 1102 has a leg 1106 that fits snuggly into gap 902 and extends to stop face 108. Weather stripping 1102 also has a resilient flange 1004 which extends at least partially over rear surface 904 (see FIG. 9A) of closure stop 109. Flange 1004 is shown as having a generally arcuate cross-sectional shape, but other shapes may be used. Flange 1004 is intended to deform when compressed by the closure of a door 110 or the like.

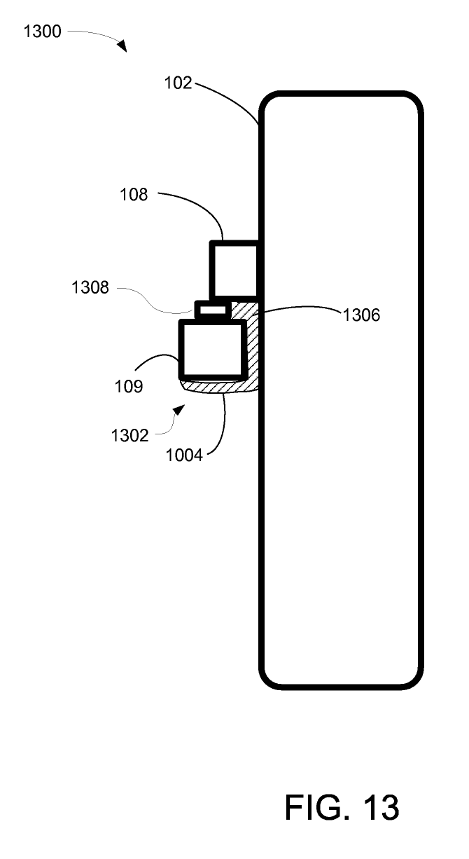

FIG. 12 shows a front elevation view of an exemplary embodiment of weather stripping 1002 for the exemplary embodiment of steel closure frame 100 of FIG. 10, according to a preferred embodiment of the present invention. Resilient legs 1006 are spaced apart by weather stripping gaps 1202 (one labeled) which are sized to accommodate joinery 113. Resilient legs 1006 are sized to fit securely in gaps 902. The weather stripping 1002 is preferably a resilient material and may be manufactured by cutting and trimming commercial-off-the-shelf weather stripping.

FIG. 13 shows a cross-sectional view similar to section B-B, defined in FIG. 9, illustrating yet another exemplary embodiment of a steel closure frame 1300 with weather stripping 1302, according to a preferred embodiment of the present invention. This embodiment includes a steel insert 1308 between stop face 108 and closure stop 109 and, preferably, joined to both stop face 108 and closure stop 109. Steel insert 1308 provides an additional step to the appearance of the closure frame 1300. Those of skill in the art, enlightened by this disclosure, will appreciate that various numbers of steel inserts 1308 that may be employed. Weather stripping 1302 preferably fills the gap between closure stop 109 and stop face 108 in this embodiment.

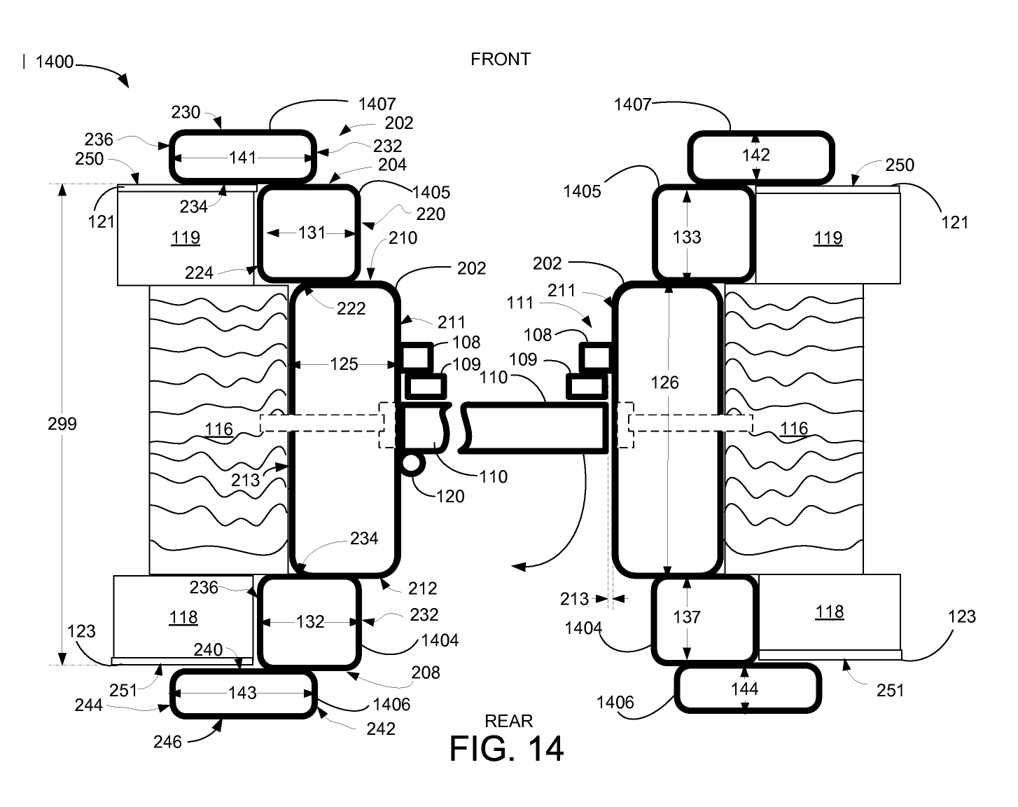

FIG. 14 shows a transverse cross-sectional view of another exemplary embodiment of a steel closure frame 1400, according to a preferred embodiment of the present invention. Outer surface 224 of front extension 1405 is not aligned to outer surface 215 of steel closure jamb 102, but is aligned to outer surface 236 of rear extension 1404. Less than all of rear surface 234 of front facing 1407 engages less than all of front surface 204 of front extension 1405. Less than all of front surface 240 of rear facing 1406 engages less than all of rear surface 208 of rear extension 1404. Accordingly, both the exterior and interior of the steel closure frame 1400 have a stepped appearance.

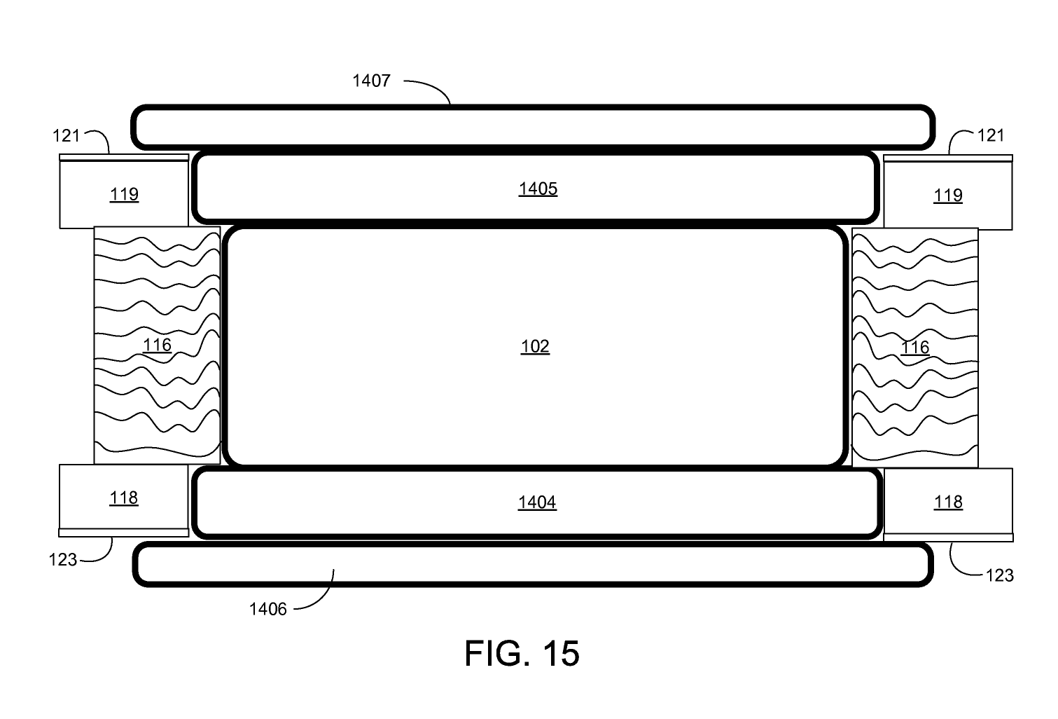

FIG. 15 shows a top plan view illustrating the exemplary embodiment of FIG. 14, according to a preferred embodiment of the present invention. Front facing 1407 extends over front finish 121 and is joined to front extension 1405. Front extension 1405 extends over at least a portion of framing stud 116 and is joined to steel closure jamb 102. Steel closure jamb 102 abuts rear extension 1404, which extends over at least a portion of framing stud 116. Rear facing 1406 extends over rear finish 123 and is joined to rear extension 1404. Abutment to wall elements 116, 118, 119, 121, and 123 by respective elements 102, 1404, 1405, 1407, and 1406 of steel closure frame 1400 is preferable, but imperfections may be sealed with a silicone caulk.

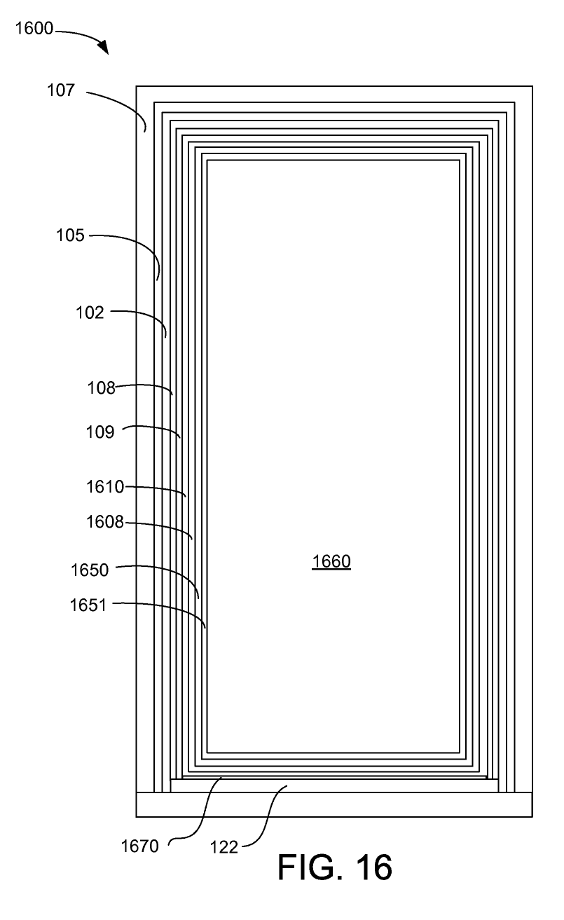

FIG. 16 shows a front elevation view illustrating an exemplary embodiment of a steel closure frame, or window frame 1650 in a larger closure frame, or door 1610, supported in an exemplary embodiment of a steel closure frame 100 of FIG. 1, according to a preferred embodiment of the present invention. Door 1610 supports window stop face 1608 that conceals window closure stop 109 (not visible in this view). Door 1610 supports window frame 1650. Glazing rim 1651 extends around an interior perimeter of window frame 1650 to support glass panel 1660. The bottom of door 1610 supports sweep 1670. Sweep 1670 is a resilient weather stripping material, preferably having a cross-sectional shape similar to a Gaussian bell curve. Sweep 1670 seals the space between doorframe 1610 and step 124.

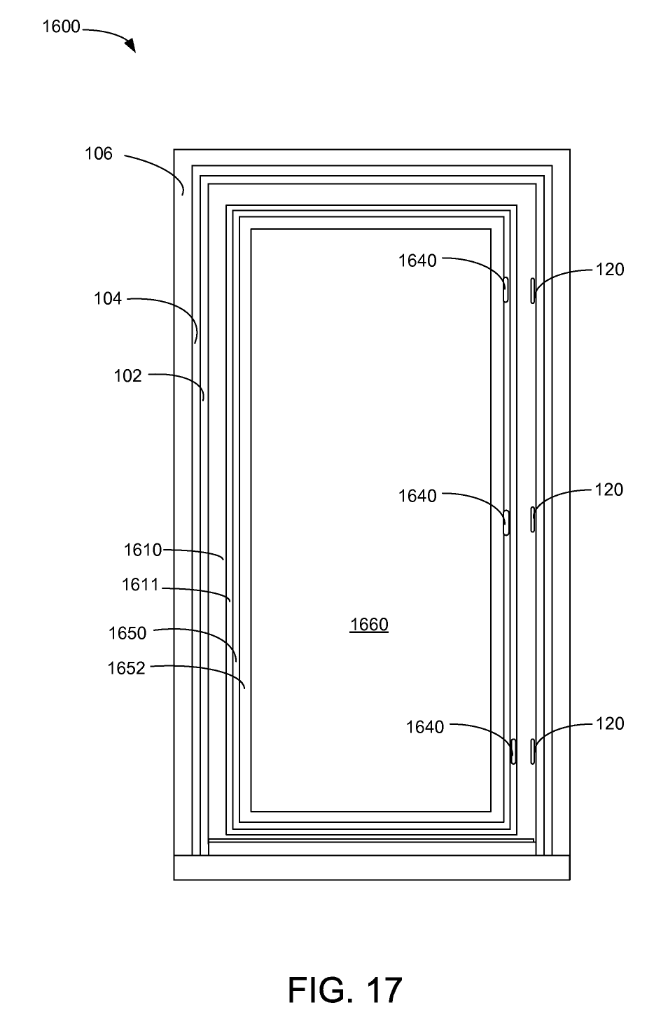

FIG. 17 shows a rear elevation view illustrating an exemplary embodiment of a steel window frame 1650 in a door 1610 supported in an exemplary embodiment of a steel closure frame 100 of FIG. 16, according to a preferred embodiment of the present invention. Steel closure jamb 102 supports door 1610 on flexible couplings 120. Door 1610 supports window frame 1650, which is spaced apart from doorframe 1610 to accommodate window flexible couplings 1640. As will be seen in more detail below, window weather stripping 1611 may be visible through the space between doorframe 1610 and window frame 1650. Glazing flange 1652 partially overlaps window frame 1650 and is fastened to window frame 1650, preferably with screws. Glazing flange 1652 is used to secure glass panel 1660 in place in window frame 1650.

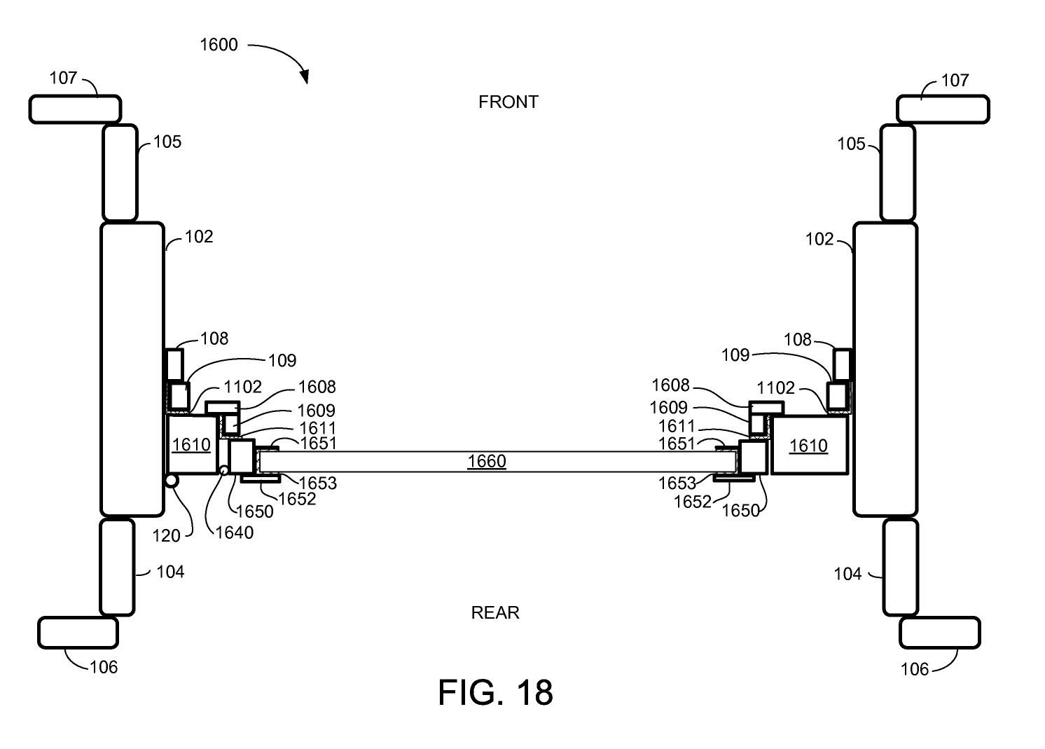

FIG. 18 is a transverse cross-sectional view illustrating the exemplary embodiment of FIG. 16, according to a preferred embodiment of the present invention. Door 1610 is supported on flexible couplings 120. Window closure stop 1609 is spaced apart from window frame 1610 and is supported by discontinuous joinery in the same manner as closure stop 109 is joined to steel closure jamb 102. Window stop face 1608 is joined to less than all of the front surface of doorframe 1610, as shown. Window closure stop 1609 is joined to less than all of the rear surface of window stop face 1608. Window closure stop 1609 and window stop face 1608 may be joined into a single part and then joined to doorframe 1610. Window weather stripping 1611 is installed in the same manner as weather stripping 1102 (see FIG. 11).

Doorframe 1610 supports window frame 1650 on flexible couplings 1640. The flexible coupling 1640 is sized and arranged such that the rear surface of doorframe 1610 and the rear surface of window frame 1650 are aligned in the same plane. Glazing rim 1651 extends inwardly (relative to the window frame) from the inner surface of window frame 1650 to support glass panel 1660 in window frame 1650. The glazing rim 1651 is preferably in a plane rearward of the plane of the front surface of window frame 1650, thereby creating a stepped appearance. Less than all of the front surface of glazing flange 1652 engages less than all of the rear surface of window frame 1650 and extends inwardly as far as glazing rim 1651. Glazing flange 1652 is fastened to window frame 1650, preferably with screws. The edge of glass panel 1660 fits between glazing rim 1651 and glazing flange 1651 with room for a silicone glazing compound 1653 which provides a secure fit and shock absorption between the glass 1660 and the steel window frame 1610, glazing rim 1651, and glazing flange 1652.

The edge of doorframe 1610 distal from the flexible coupling 120 compresses weather stripping 1102 against the rear surface of closure stop 109 when closed, as shown. A latch (not shown) is provided to releasably secure the doorframe 1610 in the closed position. The edge of window frame 1650 distal flexible coupling 1640 compresses weather stripping 1611 against the rear surface of window closure stop 1609 when closed, as shown. A latch (not shown) is provided to releasably secure the window frame 1650 in the closed position.

Although applicant has described applicant's preferred embodiments of this invention, it will be understood that the broadest scope of this invention includes modifications such as diverse shapes, sizes, and materials. For example, and without limitation, the teachings of this disclosure may be applied to doors, double doors, windows, gates, transoms, and lids. Such scope is limited only by the below claims as read in connection with the above specification. Further, many other advantages of applicant's invention will be apparent to those skilled in the art from the above descriptions and the below claims.

What is claimed is:

1. A steel closure frame, operable to be installed in a panel having a panel width, a front panel surface and a rear panel surface, said steel closure frame having a rear side and a front side and operable to support a closure that opens toward such rear side, the steel closure frame comprising:
a. at least one tubular steel closure jamb comprising a closure jamb header connecting at least two closure jamb side members defining an inner perimeter, each said closure jamb side member of said at least two closure jamb side members having a bottom end;
b. at least one partially hidden closure stop, comprising
i. at least one closure stop,
1. spaced inwardly apart from said inner perimeter of said at least one steel closure jamb by a first distance; and
2. discontinuously joined to at least a portion of said at least one steel closure jamb by joinery spanning said first distance, thereby forming at least one plurality of gaps between said at least one closure stop and said at least one steel closure jamb; and
ii. at least one closure stop face, coupled to said at least one steel closure jamb;
iii. wherein said at least one closure stop face is sized, shaped, and arranged to at least partially obscure said at least one plurality of gaps from view.

2. The steel closure frame of claim 1, wherein said at least one closure stop and said at least one closure stop face are joined.

3. The steel closure frame of claim 1, further comprising at least one intermediate stop member disposed between and coupled to at least one of said at least one closure stop face and said at least one closure stop, said at least one intermediate stop member spaced apart from said at least one steel closure jamb by a second distance.

4. The steel closure frame of claim 1, further comprising at least one resilient weather strip, said weather strip comprising:
a. at least one resilient flange sized, shaped, and arranged to extend over at least one rear surface of said at least one closure stop; and
b. at least two resilient legs extending from said at least one resilient flange, wherein each resilient leg of said at least two resilient legs is sized, shaped, and arranged to securely fit into one gap of said at least one plurality of gaps.

5. The steel closure frame of claim 1, further comprising a front extension, said front extension comprising:
a. at least one front extension member fixed to said at least one steel closure jamb and having at least one front extension front surface alignable parallel to such front panel surface; and
b. at least one front facing, fixed to less than all of said front extension front surface and extending outwardly proximate to such front panel surface.

6. The steel closure frame of claim 1, further comprising a rear extension, said rear extension comprising:
a. at least one rear extension member having at least one rear extension rear surface alignable parallel to such rear panel surface; and
b. at least one rear facing, fixed to less than all of said rear extension rear surface and extendable outwardly adjacent to such rear panel surface;
c. wherein said at least one rear extension is operable to be fixed in abutment to said at least one steel closure jamb.

7. The steel closure frame of claim 1, further comprising a footer connecting said bottom ends, said footer having a top surface.

8. The steel closure frame of claim 7, further comprising a step fixed to said top surface of said footer and further fixed to said at least one tubular steel closure jamb proximate said bottom ends.

9. The steel closure frame of claim 1, wherein said steel closure frame comprises at least one of:
a. a door frame;
b. a window frame;
c. a frame for a window in a door; and
d. a window frame within a door frame.

10. The steel closure frame of claim 1, wherein:
a. said at least one tubular steel closure jamb further comprises a tubular steel closure jamb footer connecting said closure jamb members distal said closure jamb header; and
b. said at least one closure stop spaced apart from and discontinuously joined to said at least one tubular steel closure jamb footer by said first distance.

11. The steel closure frame of claim 1, further comprising:
a. at least one closure having at least one opening, said opening sized, shaped, and arranged to serve as at least one second closure jamb, said at least one second closure jamb having at least one second inner perimeter;
b. at least one second partially hidden closure stop, comprising
i. at least one second closure stop,
1. spaced inwardly apart from said second inner perimeter of said at least one second closure jamb by said first distance; and
2. discontinuously joined to at least a portion of said at least one second closure jamb by joinery spanning said first distance, thereby forming at least one second plurality of second gaps between said at least one second closure stop and said at least one second closure jamb; and
ii. at least one second closure stop face, coupled to said at least one second closure jamb;
c. wherein said at least one second closure stop face is sized, shaped, and arranged to at least partially obscure said at least one second plurality of second gaps from view.

12. A steel closure frame, operable to be installed in a panel having a panel width, a front panel surface and a rear panel surface, said steel closure frame operable to support a closure that opens in a first direction, the steel closure frame comprising:
a. at least one steel closure jamb, comprising first steel tubing of rectangular cross-section having a closure jamb width, said first steel tubing arranged in fixed disposition comprising two side jambs connected by one header jamb, said at least one steel closure jamb having at least one front surface, at least one rear surface, at least one inner surface, at least one outer surface, and at least one foot on each side jamb of said two side jambs distal said header jamb;
b. a partially hidden closure stop, comprising:
i. at least one closure stop, operable to stop such closure at a closed position within said steel closure frame, said at least one closure stop comprising:
1. a second steel tubing of rectangular cross-section comprising at least one front surface, at least one rear surface, at least one inner surface, and at least one outer surface,
2. wherein said at least one outer surface of said at least one closure stop is:
a. spaced apart from said at least one inner surface of said at least one steel closure jamb by a first distance; and
b. discontinuously joined to said at least one inner surface of said steel closure jamb by joinery spanning said first distance, forming at least one plurality of discontinuous gaps between said at least one outer surface of said at least one closure stop and said at least one inner surface of said at least one steel closure jamb;
ii. at least one closure stop face, comprising a third steel tubing of rectangular cross-section comprising at least one front surface, at least one rear surface, at least one inner surface, and at least one outer surface, wherein said at least one front closure stop face is fixed to said at least one said inner surface of said at least one steel closure jamb; and
iii. wherein said at least one closure stop face is sized, shaped, and arranged to at least partially obscure said at least one plurality of gaps from view.

13. The steel closure frame of claim 12, further comprising at least one intermediate stop member disposed between and connected to said at least one closure stop face and said at least one closure stop, said at least one intermediate stop member spaced apart from said steel closure jamb by a second distance greater than said first distance.

14. The steel closure frame of claim 12, wherein said at least one closure stop and said at least one closure stop face are joined.

15. The steel closure frame of claim 12, further comprising a resilient weather strip, said weather strip comprising:
a. at least one continuous resilient flange sized, shaped, and arranged to extend onto said at least one rear surface of said at least one closure stop; and
b. at least two resilient legs extending from said at least one continuous resilient flange, wherein each resilient leg of said at least two resilient legs is sized, shaped, and arranged to securely fit into one gap of said at least one plurality of gaps.

16. The steel closure frame of claim 12, further comprising a front extension, said front extension comprising:
a. at least one front extension member, comprising:
i. a fourth steel tubing of rectangular cross-section arranged in fixed disposition comprising two side front extensions connected by one header front extension, said at least one front extension member having at least one front surface, at least one rear surface, at least one inner surface, at least one outer surface, and at least one foot on each side front extension of said two front extensions distal said header front extension, wherein said at least one rear surface of said front extension member is fixed to less than all of said at least one front surface of said steel closure jamb; and
ii. a front extension depth between said at least one front surface of said front extension member and said at least one rear surface of said front extension member, said front extension depth selected to align said at least one front surface of said extension member to such front panel surface; and
b. at least one front facing, comprising a fifth steel tubing of rectangular cross-section arranged in fixed disposition as two front side facings connected by one front header facing, said at least one front facing having at least one front surface, at least one rear surface, at least one inner surface, at least one outer surface, and at least one foot on each front side facing distal said front header facing, wherein said at least one rear surface of said at least one front facing is fixed to less than all of said at least one front surface of said at least one extension member.

17. The steel closure frame of claim 12, further comprising a footer fixedly connecting said feet, said footer having a top surface.

18. The steel closure frame of claim 17, further comprising a step fixed to said top surface of said footer.

19. The steel closure frame of claim 12, further comprising a rear extension, said rear extension comprising:
a. at least one rear extension member, comprising:
i. a sixth steel tubing of rectangular cross-section having at least one rear extension member width arranged in fixed disposition comprising at least two rear extension side members connected by at least one rear extension header, said at least one rear extension having a front surface, a rear surface, at least one inner surface, and at least one outer surface;
ii. at least one depth between said front surface of said at least one rear extension member and said rear surface of said rear extension member selected to align said rear surface of said at least one rear extension member to such rear panel surface of such panel;
b. at least one rear facing, comprising a seventh steel tubing of rectangular cross-section arranged in fixed disposition comprising two parallel side rear facings spaced apart and connected by a rear facing header, said at least one rear facing comprising a front surface, a rear surface, at least one inner surface, and at least one outer surface, wherein said at least one front surface of said at least one rear facing is fixed to said at least one rear surface of said rear extension member; and
c. wherein said at least one rear extension is operable to be releasably coupled to said rear surface of said at least one steel closure jamb.

20. A steel closure frame, operable to be installed in a panel having a panel width, a front panel surface, and a rear panel surface, said steel closure frame operable to support a closure that opens rearward, the steel closure frame comprising:
a. at least one steel closure jamb, comprising first steel tubing of rectangular cross-section having a closure jamb width, said first steel tubing arranged in fixed disposition comprising two side jambs connected by one header jamb, said at least one steel closure jamb having at least one rear surface, at least one inner surface, at least one outer surface, and at least one foot on each side jamb of said two side jambs distal said header jamb;
b. a partially hidden closure stop, comprising:
i. at least one closure stop, operable to stop such closure at a closed position within said steel closure frame, said at least one closure stop comprising:
1. a second steel tubing of rectangular cross-section comprising at least one front surface, at least one rear surface, at least one inner surface, and at least one outer surface,
2. wherein said at least one outer surface of said at least one closure stop is:
a. spaced apart from said at least one inner surface of said at least one steel closure jamb by a first distance; and
b. discontinuously joined to said at least one inner surface of said steel closure jamb by joinery spanning said first distance, forming at least one plurality of gaps between said at least one outer surface of said at least one closure stop and said at least one inner surface of said at least one steel closure jamb;
ii. at least one closure stop face, comprising a third steel tubing of rectangular cross-section comprising at least one front surface, at least one rear surface, at least one inner surface, and at least one outer surface, wherein said at least one closure stop face is fixed to said at least one said inner surface of said at least one steel closure jamb; and
iii. wherein said at least one closure stop face is sized, shaped, and arranged to at least partially obscure said at least one plurality of gaps from view.
c. a resilient weather strip, comprising:
i. at least one continuous resilient flange sized, shaped, and arranged to extend over said at least one rear surface of said at least one closure stop;
ii. at least one resilient leg extending from said at least one continuous resilient flange, wherein said at least one resilient leg is sized, shaped, and arranged to securely fit into one gap of said at least one plurality of discontinuous gaps;
d. at least one front extension, comprising:
i. at least one front extension member, comprising:
1. a fourth steel tubing of rectangular cross-section arranged in fixed disposition comprising two side front extensions connected by one header front extension, said at least one front extension member having at least one front surface, at least one rear surface, at least one inner surface, at least one outer surface, and at least one foot on each side front extension of said two front extensions distal said header front extension, wherein said at least one rear surface of said front extension member is fixed to less than all of said at least one front surface of said steel closure jamb; and
2. a front extension depth between said at least one front surface of said front extension member and said at least one rear surface of said front extension member, said front extension depth selected to align said at least one front surface of said extension member to such front panel surface; and
ii. at least one front facing, comprising a fifth steel tubing of rectangular cross-section arranged in fixed disposition as two front side facing connected by one front header facing, said at least one front facing having at least one front surface, at least one rear surface, at least one inner surface, at least one outer surface, and at least one foot on each front side facing distal said front header facing, wherein said at least one rear surface of said at least one front facing is fixed to less than all of said at least one front surface of said at least one front extension member;
e. a footer fixedly connecting said feet, said footer having a top surface;
f. a step fixed to said top surface of said footer and further fixed to said side jambs proximate said feet;
g. at least one rear extension, said at least one rear extension comprising:
i. a rear extension member, comprising:
1. a sixth steel tubing of rectangular cross-section having a rear extension member width arranged in fixed disposition comprising two side rear extensions connected by a rear extension header, said at least one rear extension having a front surface, a rear surface, at least one inner surface, and at least one outer surface;
2. a rear extension member depth between said front surface of said extension member and said rear surface of said extension member selected to align said rear surface of said extension member to such rear panel surface of such panel;
ii. at least one rear facing, comprising a seventh steel tubing of rectangular cross-section arranged in fixed disposition comprising two parallel side rear facings spaced apart and connected by a rear facing header, said at least one rear facing comprising a front surface, a rear surface, at least one inner surface, and at least one outer surface, wherein said at least one front surface of said at least one rear facing is fixed to said at least one rear surface of said rear extension member; and
iii. wherein said at least one rear extension member is operable to be fixed in abutment to said rear surface of said at least one steel closure jamb.

21. The steel closure frame of claim 20, further comprising:
a. at least one closure having at least one opening, said opening sized, shaped, and arranged to serve as at least one second closure jamb, said at least one second closure jamb having at least one second inner perimeter;
b. at least one second partially hidden closure stop, comprising
i. at least one second closure stop,
1. spaced inwardly apart from said second inner perimeter of said at least one second closure jamb by said first distance; and
2. discontinuously joined to at least a portion of said at least one second closure jamb by joinery spanning said first distance, thereby forming at least one second plurality of second gaps between said at least one second closure stop and said at least one second closure jamb; and
ii. at least one second closure stop face, coupled to said at least one second closure jamb;
c. wherein said at least one second closure stop face is sized, shaped, and arranged to at least partially obscure said at least one second plurality of second gaps from view;
d. at least one second closure sized, shaped, and arranged to close said at least one opening, said at least one second closure further comprising:
i. a front surface defining a front plane and a rear surface;
ii. at least one second opening, said at least one second opening having at least one second inner perimeter;
iii. at least one glazing rim extending inwardly from said at least one second perimeter and spaced apart rearward of said front plane;
iv. at least one glazing flange, attachable to said rear surface and extending inwardly from said at least one second perimeter; and
v. wherein said glazing rim, said glazing flange, and said at least one second closure are operable to secure at least one panel of glass in said at least one second opening.
